(19) United States
(12) Patent Application Publication
(10) Pub. No.: US 2019/0225297 A1
(43) Pub. Date: Jul. 25, 2019

(54) SHOCK ABSORBER

(71) Applicant: KYB Corporation, Tokyo (JP)

(72) Inventor: Takahisa MOCHIZUKI, Gifu (JP)

(73) Assignee: KYB Corporation, Tokyo (JP)

(21) Appl. No.: 16/089,001

(22) PCT Filed: Mar. 21, 2017
(86) PCT No.: PCT/JP2017/011238

§ 371 Date: Sep. 27, 2018

(30) Foreign Application Priority Data
Mar. 28, 2016 (JP) 2016-063047

(51) Int. Cl. B62K 25/10; B60G 17/027

(52) U.S. Cl. CPC B62K 25/10; B62K 2025/045; B60G 17/0272

(57) ABSTRACT

A shock absorber includes a spring bearing that supports one end of the suspension spring which biases the shock absorber main body in an extension direction; a jack configured to change an axial position of the spring bearing; a ring-shaped adapter freely fitted to an outer periphery of the spring bearing; a restricting portion disposed between the spring bearing and the adapter, the restricting portion restricting a movement of the adapter in an axial direction with respect to the spring bearing; a rotation stop member mounted on the shock absorber main body to stop a rotation of the adapter; and a stroke sensor disposed between the adapter and the rotation stop member.

### TECHNICAL FIELD

The present invention relates to a shock absorber.

### BACKGROUND ART

Conventionally, a shock absorber is used for supporting a rear wheel of a saddle-ride type vehicle, such as a two-wheeled vehicle or a three-wheeled vehicle. The shock absorber disclosed in JP2010-149548A is configured such that a jack drives a spring bearing that supports one end of a suspension spring, such as a coiled spring, to adjust a vehicle height.

Specifically, the jack in JP2010-149548A includes a housing, a piston, and a pump. The piston is movably inserted in this housing to form a liquid chamber in the housing. The pump supplies a liquid to the liquid chamber. This pump is a reciprocating pump including a single pump chamber. A liquid of a volume obtained by multiplying a piston cross-sectional area of the pump by a movement distance of the piston is supplied to the liquid chamber. In view of this, a liquid amount supplied to the liquid chamber is approximately accurately known, and thus, a position of the spring bearing is approximately accurately obtained from this liquid amount.

### SUMMARY OF INVENTION

In a shock absorber that supports a vehicle, there is a case where an adjustment amount of a vehicle height is increased for the purpose of improving foot grounding property when the vehicle stops. In this case, a reciprocating pump is unsuitable and other kinds of pumps, such as a gear pump, are suitable. However, a pump like the gear pump causes an internal leakage. Therefore, the use of such a pump fails to accurately obtain a liquid amount supplied from the pump to the liquid chamber, thus failing to accurately obtain a position of a spring bearing from the above-described liquid amount.

It is possible to detect a displacement of the spring bearing at one position in a circumferential direction by a stroke sensor mounted on a side portion of the spring bearing in order to obtain the position of the spring bearing without using the liquid amount supplied from the pump to the liquid chamber. However, in a conventional shock absorber, a suspension spring rotates the spring bearing when the suspension spring is compressed. Therefore, the stroke sensor is twisted and this sensor fails to accurately obtain an axial position of the spring bearing.

An object of the present invention is to provide a shock absorber that ensures accurately obtaining an axial position of a spring bearing.

According to one aspect of the present invention, a shock absorber includes a shock absorber main body; a suspension spring configured to bias the shock absorber main body in an extension direction; a spring bearing that supports one end of the suspension spring; a jack configured to change an axial position of the spring bearing; a ring-shaped adapter freely fitted to an outer periphery of the spring bearing; a restricting portion disposed between the spring bearing and the adapter, the restricting portion restricting a movement of the adapter in an axial direction with respect to the spring bearing; a rotation stop member mounted on the shock absorber main body to stop a rotation of the adapter; and a stroke sensor disposed between the adapter and the rotation stop member.

### BRIEF DESCRIPTION OF DRAWINGS

FIG. 1 is a side view illustrating a simplified vehicle including a shock absorber according to an embodiment of the present invention;

FIG. 2 is a partial cross-sectional view of the shock absorber according to the embodiment of the present invention in a unloaded state, illustrating a state where a piston is maximally advanced in a right side with respect to a center line and a state where the piston is maximally retreated in a left side with respect to the center line;

FIG. 3 is a view enlarging a part in FIG. 2;

FIG. 4 is a transverse sectional view enlarging and illustrating a guide, a rotation stop member, and a stroke sensor of the shock absorber according to the embodiment of the present invention;

FIG. 5 is a partially enlarged vertical cross-sectional view illustrating a peripheral area of a restricting portion of a shock absorber according to a modification of the embodiment of the present invention;

FIG. 6A is a transverse sectional view illustrating a modification of a full-closure prevention structure of a slit in a guide of the shock absorber according to the embodiment of the present invention, and enlarging and illustrating a part of the above-described guide;

FIG. 6B is a transverse sectional view illustrating another modification of a full-closure prevention structure of a slit in the guide of the shock absorber according to the embodiment of the present invention, and enlarging and illustrating a part of the above-described guide;

FIG. 7 is a transverse sectional view enlarging and illustrating a modification of an adapter of a shock absorber according to one embodiment of the present invention together with a rotation stop member and a stroke sensor; and

FIG. 8 is a partially enlarged vertical cross-sectional view of a related shock absorber.

### DESCRIPTION OF EMBODIMENTS

The following describes an embodiment of the present invention with reference to the drawings. Like reference numerals designate identical elements or corresponding components throughout some drawings.

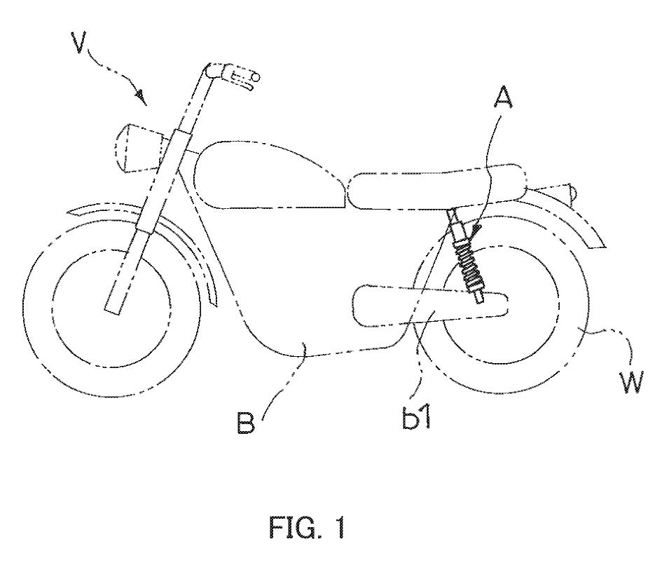

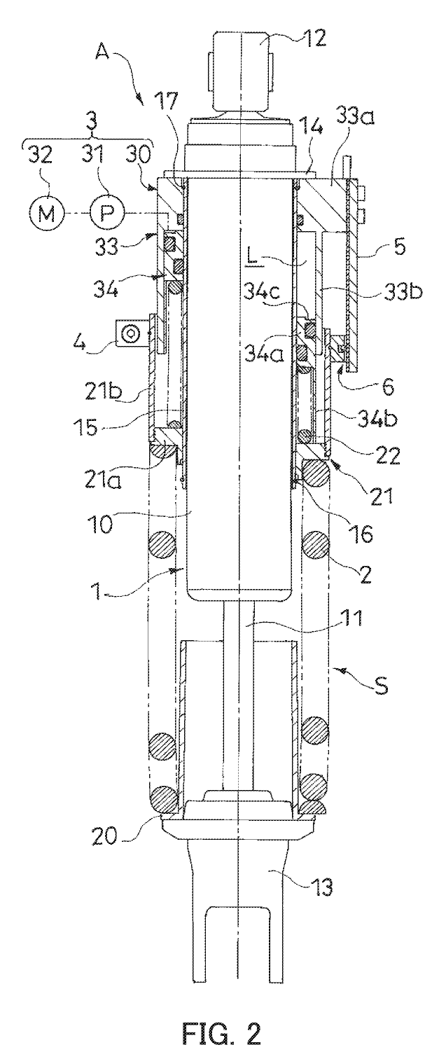

As illustrated in FIG. 1, a shock absorber A according to an embodiment of the present invention is disposed between a vehicle body B and a rear wheel W of a motorcycle V that is a vehicle. As illustrated in FIG. 2, the shock absorber A includes a shock absorber main body 1, a suspension spring 2, a spring bearing 20, a spring bearing 21, a jack 3, an auxiliary spring 22, a ring-shaped adapter 4, a rotation stop member 5, and a stroke sensor 6. The suspension spring 2 is disposed in an outer periphery of the shock absorber main body 1. The spring bearing 20 supports a lower end (an end portion at a lower side in FIG. 2) of the suspension spring 2. The spring bearing 21 supports an upper end (an end portion at an upper side in FIG. 2) of the suspension spring 2. The jack 3 adjusts a position of the spring bearing 21. The auxiliary spring 22 is disposed between the spring bearing 21 and the jack 3. The adapter 4 is freely fit to an outer periphery of the spring bearing 21. The rotation stop member 5 stops a rotation of the adapter 4. The stroke sensor 6 is disposed between the adapter 4 and the rotation stop member 5.

The shock absorber main body 1 includes a cylindrical outer shell 10 and a rod 11 movably inserted into the outer shell 10. The shock absorber main body 1 provides damping force that reduces relative movement in an axial direction of the outer shell 10 and the rod 11. On the outer shell 10 and the rod 11, brackets 12, 13 are fixed respectively. The bracket 12 fixed to the outer shell 10 is coupled to the vehicle body B (see FIG. 1). The bracket 13 fixed to the rod 11 is coupled to a swing arm b1 (see FIG. 1) that supports the rear wheel W via a link (not illustrated). When impact by unevenness of the road surface is input to the rear wheel W, the rod 11 comes in and out of the outer shell 10 to extend and contract the shock absorber main body 1, thus providing the damping force. Then, the suspension spring 2 extends and contracts together with the shock absorber main body 1, and thus, the shock absorber A extends and contracts.

The suspension spring 2, which is a coiled spring formed such that a wire rod is wound into a coil form, when being compressed, provides elastic force against this compression. The spring bearing 20 is formed into a ring shape to be disposed on an outer periphery of the rod 11. The bracket 13 at the lower side in FIG. 2 restricts the spring bearing 20 from moving downward in FIG. 2 with respect to the rod 11. The spring bearing 21 has a ring-shaped supporting portion 21a that abuts on an upper end of the suspension spring 2 in FIG. 2 and a cylindrical extending portion 21b that extends upward in FIG. 2 from the supporting portion 21a. The cylindrical extending portion 21b has a lower end in FIG. 2 coupled to the supporting portion 21a. The spring bearing 21 is disposed on an outer periphery of the outer shell 10 and supported by the auxiliary spring 22 and the jack 3.

More specifically, a flange 14 is fixed to an upper end portion on the outer periphery of the outer shell 10 so as to project outward. The outer periphery of the outer shell 10 at the lower side than the flange 14 in FIG. 2 is covered with a cylindrical guide 15. The supporting portion 21a of the spring bearing 21 is slidably in contact with an outer periphery of the guide 15. The supporting portion 21a is movable in the axial direction of the outer shell 10. On the outer periphery of the guide 15 at both ends in the axial direction, ring grooves (not illustrated) are formed along a circumferential direction. With the respective ring grooves, snap rings 16, 17 are engaged. On the outer periphery of the guide 15, the supporting portion 21a of the spring bearing 21, the auxiliary spring 22, and a jack main body 30, which is described later, of the jack 3 are disposed approximately vertically alongside in order from the lower side in FIG. 2. They are retained with both snap rings 16, 17 as a whole.

The jack 3 includes the jack main body 30, a pump 31 that supplies hydraulic oil to the jack main body 30, and a motor 32 that drives the pump 31. The pump 31 and the motor 32 may have any configurations. Thus, well-known configurations can be employed. Here, detailed descriptions of the pump 31 and the motor 32 will not be further elaborated. It should be noted that when the pump 31 is a gear pump, the pump 31 is low-priced and excellent in durability, and can quickly supply the hydraulic oil to the jack main body 30.

The jack main body 30 includes a ring-shaped housing 33 that is disposed on the outer periphery of the guide 15 and surrounds the guide 15 and a ring-shaped piston 34 that is slidably inserted between the housing 33 and the guide 15. The piston 34 forms a liquid chamber L inside the housing 33. The housing 33 is formed into a shape of a cylinder with a closed bottom with a ring-shaped base portion 33a and a cylindrical portion 33b that extends downward in FIG. 2 from the base portion 33a. Then, the housing 33 is arranged such that the base portion 33a at a bottom side faces upward in FIG. 2. The piston 34 is formed into a shape of a cylinder with a closed bottom with a ring-shaped partition wall 34a and a cylindrical spacer 34b that extends downward in FIG. 2 from an outer peripheral portion of the partition wall 34a. Then, the piston 34 is disposed such that the partition wall 34a at the bottom side faces upward in FIG. 2.

Furthermore, between the base portion 33a of the housing 33 and the guide 15, between the partition wall 34a of the piston 34 and the guide 15, and between the partition wall 34a and the cylindrical portion 33b, are covered with respective ring-shaped O-rings (not illustrated). The base portion 33a and the cylindrical portion 33b of the housing 33, the partition wall 34a of the piston 34, and the guide 15 define the liquid chamber L, and the hydraulic oil is filled into the liquid chamber L. The liquid chamber L is coupled to the pump 31 via a hose or the like. When the pump 31 supplies the hydraulic oil to the liquid chamber L, the piston 34 moves downward in FIG. 2 to expand the liquid chamber L. In contrast, when the pump 31 discharges the hydraulic oil from the liquid chamber L, the piston 34 moves upward in FIG. 2 to contract the liquid chamber L. In the following, the movement of the piston 34 in a direction to expand the liquid chamber L is also referred to as an “advance” and the movement of the piston 34 in a direction to contract the liquid chamber L is also referred to as a “retreat.”

The auxiliary spring 22, which is a coiled spring formed such that a wire rod is wound into a coil form, when being compressed, provides elastic force against the compression. The auxiliary spring 22 has a lower end (end portion at the lower side in FIG. 2) supported by the supporting portion 21a of the spring bearing 21 and an upper end (end portion at the upper side in FIG. 2) supported by the partition wall 34a of the piston 34. The auxiliary spring 22 has an inner diameter equal to or more than an inner diameter of the partition wall 34a. The auxiliary spring 22 has an outer diameter equal to or less than an inner diameter of the spacer 34b. Therefore, the auxiliary spring 22 is inserted into an inside of the spacer 34b. When the piston 34 is retreated as illustrated in the left side in FIG. 2, the auxiliary spring 22 is inserted into the cylindrical portion 33b with being supported by the partition wall 34a.

The spring bearing 21 supports the upper end of the suspension spring 2 and is movable in the axial direction of the outer shell 10 as described above. The auxiliary spring 22 is coupled to the suspension spring 2 in series via this spring bearing 21. In the following, a configuration made of the suspension spring 2, the spring bearing 21, and the auxiliary spring 22 thus coupled in series is referred to as a spring member S. Elastic force of the spring member S acts on the partition wall 34a of the piston 34. Thus, the jack main body 30 is pressed to the flange 14 by the above-described elastic force.

The housing 33 of the jack main body 30 is retained with respect to the guide 15 with the snap ring 17 at the upper side in FIG. 2. When the jack main body 30 is pressed to the flange 14 by the elastic force of the spring member S, the snap ring 17 and the flange 14 restrict the guide 15 from moving in the axial direction with respect to the outer shell 10. The elastic force of the spring member S also acts on the spring bearing 20 at the lower side in FIG. 2. Thus, the spring bearing 20 is pressed to the bracket 13 by the above-described elastic force. As a result, when the shock absorber main body 1 extends and contracts, the spring member S extends and contracts. Thus, the vehicle body B (FIG. 1) is elastically supported by this spring member S.

FIG. 2 illustrates the shock absorber A in an unloaded state (a state where no load is applied). A length of the shock absorber A in the unloaded state corresponds to a natural length of the shock absorber A, and the shock absorber main body 1 is fully extended. The right side with respect to a center line in FIG. 2 illustrates a state where the piston 34 is maximally advanced. The left side illustrates a state where the piston 34 is maximally retreated.

As illustrated in the right side in FIG. 2, in the shock absorber A, when the piston 34 is maximally advanced in the unloaded state, the spacer 34b of the piston 34 contacts the supporting portion 21a of the spring bearing 21. The piston 34 and the auxiliary spring 22 deform the suspension spring 2 by a constant amount to provide an initial deformation to the suspension spring 2. That is, a predetermined initial load is applied to the suspension spring 2. The shock absorber A may be configured such that the piston 34 and the spring bearing 21 are separated in a state where the suspension spring 2 is provided with the initial deformation and the upper side of the spring bearing 21 in FIG. 2 is supported only by the auxiliary spring 22.

The spring bearing 21 does not interfere with the snap ring 16 at the lower side in FIG. 2, even in the state where the piston 34 is maximally advanced. Accordingly, the spring bearing 21 moves without being inhibited by the snap ring 16. The snap ring 16 prevents the spring bearing 21 from getting out of the guide 15 when the shock absorber A is assembled. Therefore, the shock absorber A can be easily assembled even though the spring bearing 21 receives the elastic force of the auxiliary spring 22.

As illustrated in the left side in FIG. 2, in a state where the piston 34 is maximally retreated in the unloaded state, the piston 34 abuts on the base portion 33a of the housing 33, and a length of the suspension spring 2 and the auxiliary spring 22 becomes close to the natural length (free height). On an outer peripheral side of the partition wall 34a of the piston 34 at an upper end portion in FIG. 2, a ring-shaped recess 34c is disposed. This recess 34c is opposed to an opening of a flow passage that couples the liquid chamber L to the hose. In view of this, even in a state where the piston 34 is abutted on the base portion 33a, a pressure of the hydraulic oil can act on the recess 34c of the piston 34. That is, a pressure-receiving area of the piston 34 when the piston 34 is maximally retreated can be enlarged. It should be noted that the recess 34c may be disposed at a side of the base portion 33a.

The natural length of the auxiliary spring 22 is equal to or more than a length that the initial deformation (a compression length) of the suspension spring 2 is subtracted from a stroke length of the piston 34 (a movement distance between the state where the piston 34 is maximally advanced and the state where the piston 34 is maximally retreated).

Here, a description will be given of an action of the auxiliary spring 22. Upon explanation of the auxiliary spring 22, for example, it is assumed that a state where the piston 34 is maximally advanced and the initial load that provides an initial deformation X (mm) to the suspension spring 2 is applied to the suspension spring 2 is an optimum state of the shock absorber A, and the stroke length of the piston 34 in this state is Y (mm).

First, as a comparison example, a case without the auxiliary spring 22 is considered. Insofar as the stroke length Y of the piston 34 is in a range that does not exceed the initial deformation X of the suspension spring 2, even if the piston 34 is maximally retreated in the unloaded state, the suspension spring 2 does not become in the idle state. However, in the state without the auxiliary spring 22, when the stroke length Y of the piston 34 is increased to increase the vehicle-height adjustment amount without changing the suspension spring 2 and a condition concerning the suspension spring 2, such as the initial load on the suspension spring 2, the suspension spring 2 sometimes becomes in the idle state. Specifically, if the stroke length Y exceeds the initial deformation X, the suspension spring 2 sometimes becomes in the idle state. This is because, if the piston 34 is retreated from a maximum advanced limit in the unloaded state, and the suspension spring 2 extends by X (mm) to return to the natural length, the piston 34 can further retreat by Y−X (mm). The suspension spring 2 is movable in the axial direction by this excess retreating amount (Y−X), thus becoming idle.

In contrast, the shock absorber A includes the auxiliary spring 22. The natural length of this auxiliary spring 22 is longer than a length that the initial deformation X is subtracted from the stroke length Y of the piston 34, that is, (Y−X). Accordingly, even if the vehicle-height adjustment amount is increased without changing the suspension spring 2, the auxiliary spring 22 fills a gap by an amount that the suspension spring 2 can move in the axial direction (the excess retreating amount) to ensure preventing the suspension spring 2 from becoming in the idle state.

Furthermore, a closed height (an axial length in a maximum compressed state) of the auxiliary spring 22 is shorter than an axial length of the spacer 34b, and the auxiliary spring 22 has a spring constant significantly smaller than a spring constant of the suspension spring 2. Here, the “closed height of the auxiliary spring 22” means the axial length of the auxiliary spring 22 in a state where the shock absorber A is maximally compressed. The “axial length” means the length in the axial direction. In the following, an “axial position” means a position in the axial direction.

The auxiliary spring 22 will be described specifically. In a state where a vehicle weight of the vehicle V (FIG. 1) that is stopped (motionless) on a horizontal ground acts on the shock absorber A, that is, a 1G state, the auxiliary spring 22 contracts until the auxiliary spring 22 has a length that corresponds to the axial length of the spacer 34b. The spring bearing 21 butts on a distal end of the spacer 34b, and thus, an approach of the spring bearing 21 to the partition wall 34a is restricted. Accordingly, a compression of the auxiliary spring 22 is inhibited by the spacer 34b, and the spring bearing 21 is supported by the auxiliary spring 22 and the spacer 34b of the piston 34.

That is, in the 1G state, the spacer 34b restricts the spring bearing 21 from approaching the partition wall 34a of the piston 34, thus inhibiting the compression of the auxiliary spring 22. In view of this, a spring constant of the spring member S corresponds to the spring constant of the suspension spring 2. Therefore, the vehicle body B is substantially supported only by the suspension spring 2. It should be noted that the spacer 34b may be eliminated, and in this case, the auxiliary spring 22 has the closed height in the 1G state. That is, the spring bearing 21 may be brought into contact with the spacer 34b in a getting-on 1G state or the auxiliary spring 22 may have the closed height. Meanwhile, the suspension spring 2 is set so as not to have the closed height even when the shock absorber A is in a maximum contracted state.

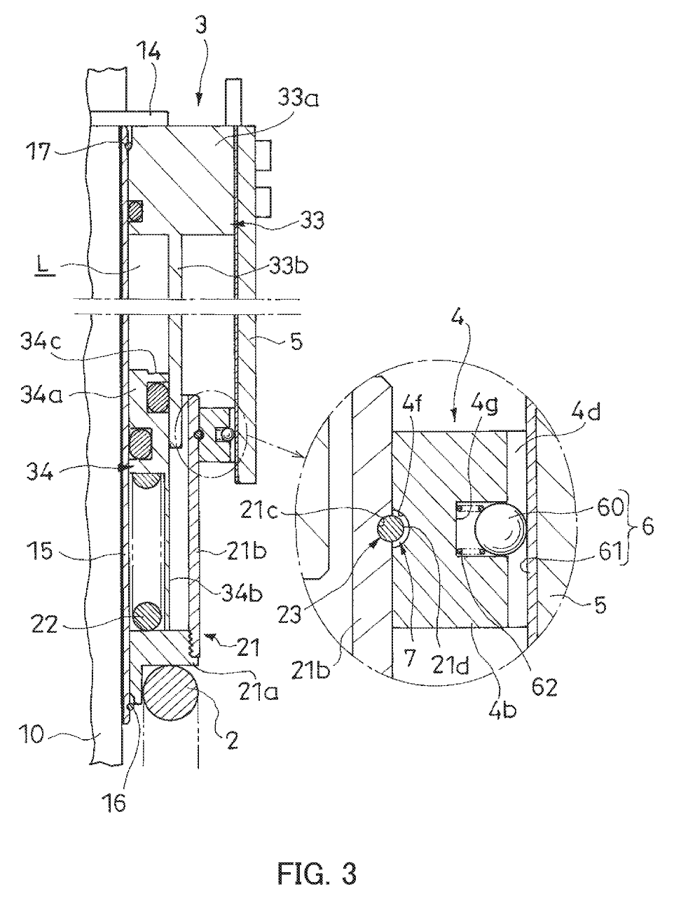

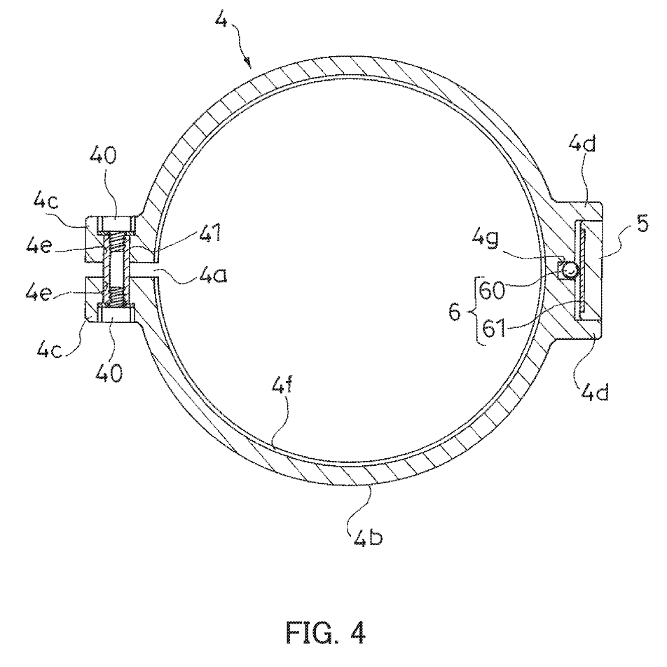

As illustrated in FIG. 3, the movement of the ring-shaped adapter 4 in the axial direction with respect to the spring bearing 21 is restricted by a restricting portion 7. The ring-shaped adapter 4 is stopped from rotating with respect to the shock absorber main body 1 by the rotation stop member 5. Describing in more details, as illustrated in FIG. 4, the adapter 4 includes a mounting portion 4b, a pair of tightening portions 4c, 4c, a pair of sandwiching portions 4d, 4d, bolts 40, and a spacer 41. The mounting portion 4b has a slit 4a at one position in the circumferential direction and is formed into an approximately C-shape in a plan view. The pair of tightening portions 4c, 4c oppose to one another from both ends of the mounting portion 4b in the circumferential direction and project outward. The pair of sandwiching portions 4d, 4d project outward from an opposite side to the tightening portions 4c in the mounting portion 4b. The bolts 40 close the slit 4a of the mounting portion 4b. The spacer 41 prevents the slit 4a from being fully closed.

The pair of tightening portions 4c, 4c extend in a diameter direction of the mounting portion 4b and have opposed surfaces that oppose to one another. The tightening portions 4c, 4c have insertion holes 4e that are approximately perpendicular to the opposed surfaces and pass through the tightening portions 4c, 4c. The spacer 41 is inserted from the insertion hole 4e of one tightening portion 4c to the insertion hole 4e of the other tightening portion 4c. The spacer 41 has both ends from which the bolts 40, 40 are screwed. Even though the bolts 40, 40 are screwed into the spacer 41 up to the limit, there generates a clearance between the tightening portions 4c, 4c, and thus, the slit 4a is not closed. Thus, the spacer 41 prevents an inner diameter of the mounting portion 4b from becoming smaller than a predetermined diameter.

On an inner periphery of the mounting portion 4b, a concave portion 4f is formed along the circumferential direction. As illustrated in FIG. 3, on the outer periphery of the extending portion 21b in the spring bearing 21, a ring groove 21c along the circumferential direction is formed. A snap ring 23 fits into the ring groove 21c. The snap ring 23 in a state of being fitted into the ring groove 21c of the spring bearing 21 has an outer diameter larger than outer diameters of portions other than the ring groove 21c in the extending portion 21b, and therefore, the snap ring 23 projects outward from the outer periphery of the extending portion 21b.

In the snap ring 23, a portion that projects outward from the extending portion 21b in a state of being mounted on the spring bearing 21 is a convex portion 21d. The convex portion 21d fits to the concave portion 4f of the adapter 4. The convex portion 21d and the concave portion 4f both have semicircular-shaped vertical cross sections. Then, a diameter of a circle passing through a top of the convex portion 21d is a maximum outer diameter of the convex portion 21d. An outer diameter of portions other than the convex portion 21d in the extending portion 21b is a maximum outer diameter of the extending portion 21b. A diameter of a circle passing through the deepest portion of the concave portion 4f in a state where the bolts 40, 40 are fastened to the spacer 41 as the adapter 4 alone (see FIG. 4) is a maximum inner diameter of the concave portion 4f. An inner diameter of portions other than the concave portion 4f of the mounting portion 4b is a minimum inner diameter of the mounting portion 4b. The maximum outer diameter of the convex portion 21d is equal to or less than the maximum inner diameter of the concave portion 4f, and the maximum outer diameter of the extending portion 21b is equal to or less than the minimum inner diameter of the mounting portion 4b.

With the above-described configuration, the spring bearing 21 including the convex portion 21d is not fastened by the adapter 4 even when the bolts 40 (see FIG. 4) of the adapter 4 are fastened. Therefore, the adapter 4 can rotate in a circumferential direction (around an axis of the spring bearing 21) with respect to the spring bearing 21. The maximum outer diameter of the convex portion 21d is greater than the minimum inner diameter of the mounting portion 4b. Therefore, the convex portion 21d restricts the movement of the adapter 4 in the axial direction with respect to the spring bearing 21. That is, in this embodiment, the convex portion 21d and the concave portion 4f form the restricting portion 7 that restricts the movement of the adapter 4 in the axial direction with respect to the spring bearing 21. The convex portion 21d and the concave portion 4f are both in ring shapes. Therefore, the restricting portion 7 permits the rotation of the adapter 4 in the circumferential direction with respect to the spring bearing 21.

The pair of sandwiching portions 4d, 4d of the adapter 4 mutually extend in parallel along a diameter direction of the mounting portion 4b as illustrated in FIG. 4, and are arranged with a predetermined interval in a circumferential direction of the mounting portion 4b. The rotation stop member 5 is sandwiched from both sides of the rotation stop member 5 by the sandwiching portions 4d, 4d. Then, on an outer periphery portion of a portion positioned between the sandwiching portions 4d, 4d in the mounting portion 4b, a groove 4g is formed. The stroke sensor 6 includes a sphere-shaped input element 60, which will be described later, inserted into this groove 4g.

As illustrated in FIG. 2, the rotation stop member 5 is a member in a rectangular plate shape extending downward in FIG. 2 from the base portion 33a of the housing 33. An upper end of the rotation stop member 5 in FIG. 2 is fixed to the base portion 33a. The sandwiching portions 4d (FIG. 4) of the adapter 4 contact both side edges (an end portion in a paper-surface-front side and an end portion in a paper-surface-back side in FIG. 2) of the rotation stop member 5. The sandwiching portions 4d restrict the mounting portion 4b of the adapter 4 from rotating with respect to the rotation stop member 5. The rotation stop member 5 has a constant width in a vertical direction in FIG. 2. Therefore, the adapter 4 is movable in the vertical direction in FIG. 2 with respect to the rotation stop member 5.

The rotation stop member 5 has an internal surface that faces a side of the shock absorber main body 1. The stroke sensor 6 includes a sensor unit 61 (FIGS. 3 and 4) that is laminated onto the internal surface of the rotation stop member 5 and the input element 60 (FIGS. 3 and 4) that is pressed onto the sensor unit 61 by a spring 62 (FIG. 3). The input element 60 is mounted on the adapter 4. Then, the stroke sensor 6 detects a change in a position of the input element 60, which contacts the sensor unit 61.

The following describes an operation of the shock absorber A according to this embodiment.

When the vehicle V starts running, the pump 31 supplies the hydraulic oil to the liquid chamber L and the piston 34 advances. The piston 34, the auxiliary spring 22, the spring bearing 21, the suspension spring 2, the spring bearing 20, and the bracket 13 move downward with respect to the outer shell 10. This exits the rod 11 from the outer shell 10 to extend the shock absorber A. As a result, the vehicle body B raises. In contrast, when the speed is reduced to stop the vehicle V, the pump 31 discharges the hydraulic oil from the liquid chamber L to retreat the piston 34. The piston 34, the auxiliary spring 22, the spring bearing 21, the suspension spring 2, the spring bearing 20, and the bracket 13 move upward with respect to the outer shell 10. This inserts the rod 11 into the outer shell 10 to contract the shock absorber A. As a result, the vehicle body B descends.

During ordinary vehicle running, specifically when, the vehicle V runs in a state where, for example, the vehicle weight, a weight of occupant, and a weight of baggage is acting on the shock absorber A, the supporting portion 21a of the spring bearing 21 abuts on the spacer 34b of the piston 34, and thus this spacer 34b inhibits the compression of the auxiliary spring 22. Accordingly, during the ordinary vehicle running, the spring member S behaves as if the spring member S is formed only of the suspension spring 2. Meanwhile, for example, when the shock absorber A fully extends as in climbing over a difference in level, even though the piston 34 is in the state of being maximally retreated, the auxiliary spring 22 extends to prevent the suspension spring 2 from becoming idle.

Also when the vehicle V stops, the vehicle weight and the like acts on the shock absorber A. Thus, the supporting portion 21a of the spring bearing 21 is maintained in a state of abutting on the spacer 34b.

Furthermore, when vehicle-height is adjusted where the piston 34 is driven as described above, the vehicle weight and the like usually acts on the shock absorber A. Therefore, the supporting portion 21a of the spring bearing 21 abuts on the spacer 34b of the piston 34 and moves in a state of being supported by this piston 34. The adapter 4 is mounted on the spring bearing 21 in a state where a movement in the axial direction with respect to the spring bearing 21 is restricted, and the pair of sandwiching portions 4d, 4d of the adapter 4 sandwich the rotation stop member 5. In view of this, when the piston 34 is moved, the spring bearing 21 moves down and up in FIG. 2 in a state of abutting on the spacer 34b of the piston 34 and the adapter 4 slides down and up in FIG. 2 along the rotation stop member 5. Upon a change in a position of the input element 60, the stroke sensor 6 detects a displacement of the spring bearing 21 in the axial direction with respect to the outer shell 10 on the basis of the position of the input element 60 with respect to the sensor unit 61. Detecting the position of the spring bearing 21 with the stroke sensor 6 ensures obtaining the position of the spring bearing 21 even when the position of the spring bearing 21 cannot be obtained from an extension and contraction amount of the shock absorber main body 1 due to changes in an extension and contraction amount of the suspension spring 2, such as during the vehicle running. Therefore, the vehicle-height adjustment during the vehicle running is possible.

The above-described adapter 4 is rotatable with respect to the spring bearing 21. In view of this, when a rotational force acts on the spring bearing 21 by the compression of the suspension spring 2, the spring bearing 21 receives the above-described rotational force and can rotate even though the adapter 4 is stopped from rotating with respect to the shock absorber main body 1 by the rotation stop member 5. Accordingly, the above-described rotational force is not applied to the sandwiching portions 4d of the adapter 4, which slide with the rotation stop member 5, and thus, the adapter 4 can slide without a resistance. In view of this, the spring bearing 21 does not incline even when the spring bearing 21 moves up and down in a state of receiving the rotational force by the compression of the suspension spring 2. Therefore, a uniform force is applied to the piston 34. Accordingly, severe abrasions of the piston 34 and the housing 33 caused by the inclination of the piston 34 can be prevented.

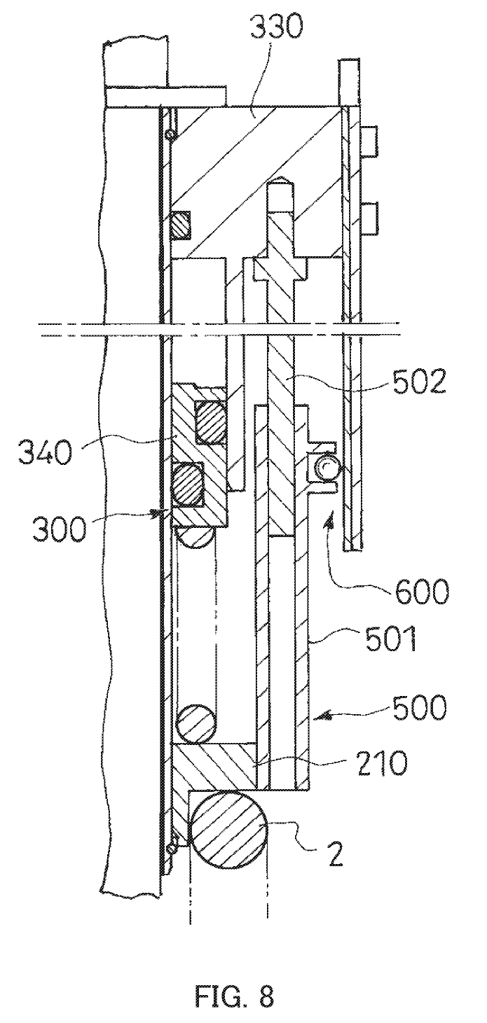

Here, a related shock absorber proposed in JP2015-150252 will be described with reference to FIG. 8. FIG. 8 is a vertical cross-sectional view of a shock absorber that can obtain an axial position of a spring bearing regardless of a kind of a pump. As illustrated in FIG. 8, in the related shock absorber, a rotation of a spring bearing 210 is restricted by a rotation stop member 500, and a displacement of this spring bearing 210 is detected by a stroke sensor 600. The rotation stop member 500 includes a cylindrical arm 501 mounted on a side portion of the ring-shaped spring bearing 210 and a rod 502 mounted on a housing 330 of a jack 300 and slidably inserted into the arm 501.

With the related shock absorber, while a contraction of the suspension spring 2 inputs a rotational force to the spring bearing 210, the rod 502 restricts rotations of the spring bearing 210 and the arm 501. When the spring bearing 210 moves up and down in FIG. 8 by extension and contraction of the suspension spring 2, the rod 502 comes in and out of the arm 501 to extend and contract the rotation stop member 500. That is, while the rotation stop member 500 restricts the rotation of the spring bearing 210, the movement of the spring bearing 210 in the axial direction is permitted. Therefore, even though the stroke sensor 600 is configured to detect an axial displacement at one position in a circumferential direction of the spring bearing 210, the stroke sensor 600 is not twisted. Accordingly, the axial position of the spring bearing 210 can be accurately obtained.

However, a rotational force by the contraction of the suspension spring 2 acts on a sliding portion between the rod 502 and the arm 501 in the rotation stop member 500. Therefore, there is a possibility that the rotation stop member 500 has difficulty in extending and contracting due to a large friction force between the arm 501 and the rod 502. When the rotation stop member 500 has difficulty in extending and contracting, a moving speed of a side coupled to the rotation stop member 500 becomes slow compared with a moving speed of a side not coupled to the rotation stop member 500 in the spring bearing 210, thus possibly causing an inclination of the spring bearing 210 with respect to the axial direction. When the spring bearing 210 inclines, a load applied to a piston 340 by the jack 300 is not uniform (an unbalanced load is applied). This possibly causes the piston 340 to incline in the housing 330 to lead to severe abrasions of the piston 340 and the housing 330.

In contrast to this, the shock absorber A according to the embodiment can easily detect the axial position of the spring bearing 21 from the axial position of the piston 34 even though the piston 34 rotates. That is, it is not necessary to restrict the rotation of the spring bearing 21 even in the shock absorber A in which, when being compressed, the suspension spring 2 causes the rotational force to act on the piston 34 via the spring bearing 21. Thus, the rotation stop member 5 does not inhibit the spring bearing 21 from moving in the axial direction. Therefore, the application of the unbalanced load on the piston 34 due to the inclination of the spring bearing 21 can be reduced. Accordingly, the abrasions of the piston 34 and the housing 33 of the jack main body 30 can be reduced.

The following describes operational advantage of the shock absorber A according to the embodiment.

In this embodiment, the spring bearing 21 has the supporting portion 21a, which supports the upper end (one end) of the suspension spring 2, and the extending portion 21b, which extends to the upper side (anti-suspension spring side) from the supporting portion 21a. The adapter 4 is mounted on the extending portion 21b. As described above, the extending portion 21b extends to an opposite side of the suspension spring 2 from the supporting portion 21a and is disposed over the auxiliary spring 22 and the piston 34 in the outside (an opposite side of the shock absorber main body 1). Accordingly, the mounting position of the adapter 4 can be made close to the base portion 33a of the housing 33 to which the rotation stop member 5 is coupled.

It should be noted that the configuration of the spring bearing 21 is not limited to the above-described configuration. For example, the extending portion 21b may be eliminated, and the adapter 4 may be mounted on the supporting portion 21a. In this case, it is necessary to shift the rotation stop member 5 downward in FIG. 2. It is difficult to move the base portion 33a downward since a coupling port to which a hose for supplying the liquid to the liquid chamber L is coupled needs to be disposed in the base portion 33a of the housing 33. Projecting a part of the housing 33 to the lower side in FIG. 2 so as to cause the rotation stop member 5 to be coupled to this portion causes a complicated shape of the housing 33. Causing the rotation stop member 5 to be coupled to the housing 33 without changing the shape of the housing 33 requires an extension of the rotation stop member 5. In this embodiment, the extending portion 21b is disposed in the spring bearing 21, and the adapter 4 is mounted on this extending portion 21b, thereby simplifying the shape of the housing 33 and ensuring shortening the rotation stop member 5.

One end of the cylindrical extending portion 21b is screwed with the supporting portion 21a, and thus the spring bearing 21 is formed. The supporting portion 21a and the extending portion 21b may be preliminarily integrated as one member. Furthermore, the extending portion 21b is formed into a pipe shape. The extending portion 21b has an inner diameter greater than an outer diameter of the cylindrical portion 33b of the housing 33. Therefore, a clearance is formed between the extending portion 21b and the cylindrical portion 33b, thereby preventing interference between the extending portion 21b and the housing 33. The extending portion 21b may be slidably in contact with the outer periphery of the housing 33. The configuration of the extending portion 21b can be changed as necessary as long as the adapter 4 can be supported. For example, the extending portion 21b may be configured by including a plurality of rods or one or more plates arranged in the circumferential direction of the supporting portion 21a.

In this embodiment, the stroke sensor 6 includes the input element 60, which is disposed in the adapter 4, and the sensor unit 61, which is mounted on the rotation stop member 5 and detects the position of the input element 60. The adapter 4 is disposed close to the rotation stop member 5 such that the rotation stop member 5 stops the rotation of the adapter 4. Accordingly, disposing the input element 60 on the adapter 4 and disposing the sensor unit 61 on the rotation stop member 5 as described above ensure preventing deviations of the input element 60 and the sensor unit 61 in a rotation direction and easily brings the input element 60 into contact with the sensor unit 61.

That is, the above-described configuration ensures simplifying the configuration of the sensor and reducing a size of the sensor when the stroke sensor 6 is a contact type. This prevents the shock absorber A from increasing in size, thereby ensuring an improved mountability of the shock absorber A. It should be noted that the configuration of the stroke sensor 6 is not limited to the above-described configuration and can be changed as necessary. For example, a non-contact sensor may be used as the stroke sensor 6 or a wire sensor that detects a displacement amount from a length of a wire extracted in association with the movement of the adapter 4 with respect to the rotation stop member 5 may be used. Such changes can be made irrespective of the configuration of the spring bearing 21.

In this embodiment, the restricting portion 7 includes the convex portion 21d, which is disposed in the spring bearing 21 and the concave portion 4f, which is disposed in the adapter 4. Since the restricting portion 7 is formed of the concavity and the convexity, the configuration of the restricting portion 7 is significantly simplified, thereby ensuring a reduced cost. Furthermore, the outer diameter of the adapter 4 can be decreased, thereby ensuring downsizing the shock absorber A. It should be noted that the configuration of the restricting portion 7 is not limited to the above-described configuration and can be changed as necessary as long as the movement of the adapter 4 in the axial direction with respect to the spring bearing 21 can be prevented without inhibiting the rotation of the adapter 4 with respect to the spring bearing 21.

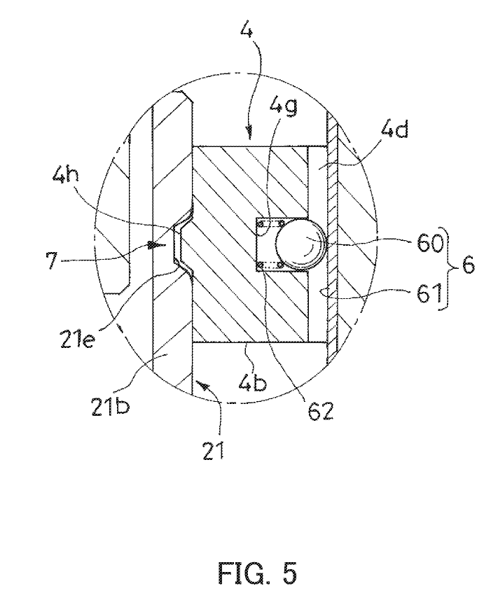

In this embodiment, the convex portion 21d is formed by the outer periphery portion of the snap ring 23 mounted on the outer periphery of the spring bearing 21. The convex portion 21d may be formed by causing a part of the spring bearing 21 to project outward. As illustrated in FIG. 5, the restricting portion 7 may be formed by a convex portion 4h disposed in the inner periphery of the adapter 4 and a concave portion 21e disposed in the outer periphery of the spring bearing 21 and to which the convex portion 4h fits. When the restricting portion 7 are configured of the concavity and the convexity, the convex portions 21d, 4h may be a plurality of projections arranged in the circumferential direction as long as the concave portions 4f, 21e are formed into ring shapes. The convex portions 21d, 4h formed into the ring shapes does not inhibit the rotation of the adapter 4 with respect to the spring bearing 21 even though the concave portions 4f, 21e are interrupted by, for example, the slit 4a as illustrated in FIG. 4. If, the convex portions 21d, 4h were the plurality of projections arranged in the circumferential direction and the concave portions 4f, 21e were interrupted in the circumferential direction, a part of the convex portions 21d, 4h (projections) could be disengaged from the concave portions 4f, 21e when the adapter 4 rotates with respect to the spring bearing 21. It is possible that the part of the convex portions 21d, 4h (projections) once disengaged from the concave portions 4f, 21e is not inserted to the concave portions 4f, 21e again. When the convex portions 21d, 4h are formed into the ring-shaped shapes, disengagement of the convex portions 21d, 4h (projections) from the concave portions 4f, 21e can be prevented. Then, such changes can be made irrespective of the configuration of the spring bearing 21 and the stroke sensor 6.

In this embodiment, the adapter 4 has the slit 4a disposed at one position in the circumferential direction. In view of this, widening the slit 4a ensures easily mounting the adapter 4 to the outer periphery of the spring bearing 21, and closing the slit 4a ensures easily preventing the adapter 4 from disengaging from the outer periphery of the spring bearing 21. A count of the slit 4a can be changed as necessary. For example, the slits 4a may be disposed at two positions in the mounting portion 4b so as to divide the mounting portion 4b into two members having arc shapes. The mounting portion 4b may be divided into three or more. Making the adapter 4 dividable into a plurality of members ensures forming the adapter 4 with a material that is insusceptible to elastic deformation. Furthermore, when the mounting portion 4b has stretch properties or when a restriction of the movement of the adapter 4 in the axial direction with respect to the spring bearing 21 is possible after the adapter 4 is mounted on the outer periphery of the spring bearing 21, the slit 4a of the adapter 4 may be eliminated and the mounting portion 4b may be formed into a ring shape. Such changes can be made irrespective of the configurations of the spring bearing 21, the stroke sensor 6, and the restricting portion 7.

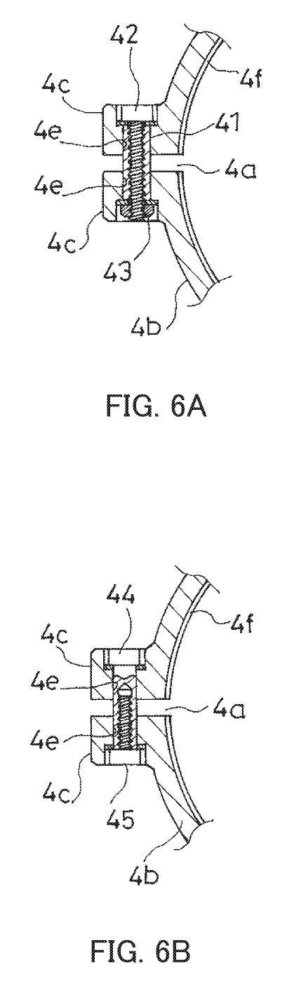

In this embodiment, the slit 4a is disposed in the adapter 4 while the slit 4a is configured not to be fully closed, and thus, the adapter 4 is mounted (freely fit) to the outer periphery of the spring bearing 21 while the movement of the adapter 4 with respect to the spring bearing 21 is permitted. The method for the free fit can be changed as necessary. For example, the configuration for preventing the slit 4a from being fully closed may be changed as illustrated in FIG. 6A and FIG. 6B. In FIG. 6A, a bolt 42 is screwed with the inner periphery of the spacer 41, a distal end of a screw shaft of the bolt 42 projects out from the spacer 41, and a nut 43 is screwed with this projecting portion. In FIG. 6B, a high nut 44 with a head is inserted from an insertion hole 4e of one of the tightening portions 4c to the insertion hole 4e of the other tightening portion 4c and a bolt 45 is screwed from a distal end of the high nut 44. When the slit 4a is prevented from being fully closed using the spacer 41 or the high nut 44, it is possible to decrease a resistance when the adapter 4 and the spring bearing 21 relatively rotate by making the inner diameter of the mounting portion 4b larger than the outer diameter of the spring bearing 21.

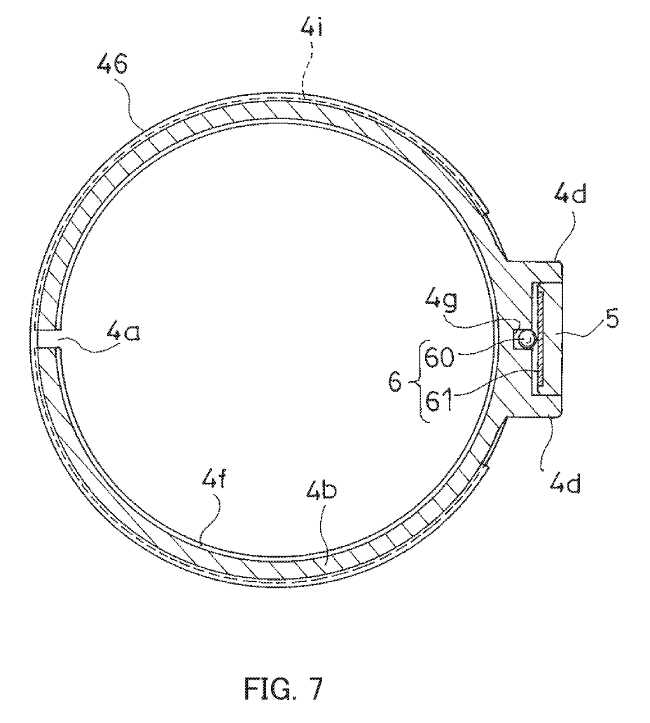

The state where the adapter 4 freely fits to the spring bearing 21 is not limited to the state where a clearance is made between the adapter 4 and the spring bearing 21 but the spring bearing 21 may slide the adapter 4 as long as the spring bearing 21 moves relative to the adapter 4. For example, as illustrated in FIG. 7, a groove 4i is disposed on the outer periphery of the mounting portion 4b along the circumferential direction, and a fastening force of a snap ring 46 that fits to the groove 4i may be configured to allow the movement of the adapter 4 with respect to the spring bearing 21. Such changes can be made irrespective of the configurations of the spring bearing 21, the stroke sensor 6, and the restricting portion 7.

In this embodiment, the shock absorber A includes the shock absorber main body 1, the suspension spring 2, which biases the shock absorber main body 1 in the extension direction, the spring bearing 21, which supports the upper end (one end) of the suspension spring 2 in FIG. 2, the jack 3, which changes the axial position of the spring bearing 21, the ring-shaped adapter 4, which is freely fit to the outer periphery of the spring bearing 21, the restricting portion 7, which is disposed between the spring bearing 21 and the adapter 4 and restricts the movement of the adapter 4 in the axial direction with respect to the spring bearing 21, the rotation stop member 5, which is mounted on the shock absorber main body 1 and stops the rotation of the adapter 4, and the stroke sensor 6, which is disposed between the adapter 4 and the rotation stop member 5.

Thus disposing the stroke sensor 6 ensures easily obtaining the position of the spring bearing 21 in the axial direction irrespective of a kind of the pump 31 that constitutes the jack 3. Therefore, a pump optimum for the adjustment amount of the vehicle height and timing of the vehicle-height adjustment can be employed. In particular, when a pump with an internal leakage, such as a gear pump or a vane pump, is used as the pump 31 that supplies the hydraulic oil to the liquid chamber L, the liquid amount of the liquid transmitted to the liquid chamber L from the pump 31 is not accurately obtained. In view of this, it is difficult to obtain the position of the spring bearing 21 on the basis of the liquid amount. This embodiment is effective for a shock absorber that uses such pump 31. Then, when the vehicle is run and stopped upon receiving a signal of, for example, a permission to proceed and indication to stop by a traffic light machine, use of the gear pump is suitable in order to adjust the vehicle-height to obtain a satisfactory foot grounding property. This is because the gear pump has an excellent durability and ensures a large discharge amount per unit time, and therefore, it can be used for a long period of time even with many vehicle-height adjustments and the adjustment can be made in a short time even with a large vehicle-height adjustment width.

The adapter 4 being freely fitted to the outer periphery of the spring bearing 21 means that the adapter 4 is fitted to the outer periphery of the spring bearing 21 so as to move with respect to the spring bearing 21, that is, in a idle state. Then, when the movement of the adapter 4 in the axial direction with respect to the spring bearing 21 is restricted by the restricting portion 7 in a state where the adapter 4 is freely fitted to the spring bearing 21, the adapter 4 can rotate in the circumferential direction along the outer periphery of the spring bearing 21 at a predetermined position of the spring bearing 21 in the axial direction.

With the above-described configuration, while the rotation of the adapter 4 is restricted by the rotation stop member 5, the adapter 4 is rotatable with respect to the spring bearing 21. Therefore, when the suspension spring 2 is compressed and the rotational force acts on the spring bearing 21, the spring bearing 21 can rotate with respect to the adapter 4 upon receiving the rotational force. Accordingly, even when a relative rotation of the adapter 4 and the rotation stop member 5 is restricted in order to dispose the stroke sensor 6, the above-described rotational force hardly acts on the sandwiching portions 4d that restrict the rotation of the adapter 4 and the rotation stop member 5. Therefore, the friction force between the sandwiching portions 4d and the rotation stop member 5 does not increase, and therefore, the adapter 4 can slide along the rotation stop member 5 without a resistance. That is, even though the rotation of the adapter 4 is restricted, the adapter 4 smoothly moves in the axial direction so as not to inhibit the movement of the spring bearing 21 in the axial direction, thereby ensuring preventing the spring bearing 21 from moving in a state of being inclined. In view of this, a uniform load can be applied to the piston 34, and thus, the piston 34 does not incline, thereby ensuring reduced abrasions of the piston 34 and the housing 33.

It should be noted that, in this embodiment, the pair of sandwiching portions 4d, 4d are disposed on the adapter 4, and the rotation stop member 5 is inserted between these sandwiching portions 4d to stop the rotation of the adapter 4. The structure that restricts the rotation of the adapter 4 can be changed as necessary. For example, the adapter 4 may include a ring, and then, a column-shaped rod as the rotation stop member 5 may be inserted through the above-described ring. Furthermore, in this embodiment, while the rotation stop member 5 is mounted on the shock absorber main body 1 via the housing 33, the rotation stop member 5 may be directly mounted on the shock absorber main body 1 or may be mounted via another member other than the housing 33. That is, the rotation stop member 5 is only necessary not to move with respect to the shock absorber main body 1.

In this embodiment, the shock absorber A includes the auxiliary spring 22, which is interposed between the piston 34 and the spring bearing 21, and the spacer 34b, which is disposed in parallel with the auxiliary spring 22. The spacer 34b is disposed on the piston 34. The spacer 34b has the axial length longer than the closed height of the auxiliary spring 22.

Thus, disposing the auxiliary spring 22 ensures preventing the suspension spring 2 from becoming in the idle state even though the adjustment amount of the vehicle height is increased without changing the suspension spring 2. The axial length of the spacer 34b of the piston 34 is longer than the closed height of the auxiliary spring 22. Therefore, the auxiliary spring 22 receives no load in a state where the auxiliary spring 22 has the closed height, that is, a state where coil portions (one wind of the auxiliary spring 22) are in contact with one another. Accordingly, it is possible to prevent a stress equal to or more than an allowable stress from acting on the wire rod forming the auxiliary spring 22. Then, when the auxiliary spring 22 is disposed inside the spacer 34b, the auxiliary spring 22 is arranged between the partition wall 34a of the piston 34 and the spring bearing 21. Therefore, increasing the axial length of the partition wall 34a of the piston 34 increases the axial length of the shock absorber A. From such a reason, it is difficult to reduce the inclination of the piston 34 by increasing a fitting length of the piston 34 with respect to the outer shell 10. In the shock absorber A including the auxiliary spring 22 in particular, it is preferred to reduce the inclination of the piston 34 using the adapter 4, the restricting portion 7, the rotation stop member 5, and the stroke sensor 6 as described above.

It should be noted that the configuration of the piston 34 is not limited to the above-described configuration and can be changed as necessary. For example, while in the shock absorber A, the partition wall 34a and the spacer 34b of the piston 34 are integrally formed as one component, these may be integrated by, for example, welding, bonding, and screwing after being formed separately. The spacer 34b may be eliminated from the piston 34 and the spacer 34b may be disposed on the spring bearing 21, or the auxiliary spring 22 and the spacer 34b may be eliminated.

In this embodiment, while the guide 15 is disposed in the outer periphery of the outer shell 10 and the guide 15 is slidably in contact with the spring bearing 21 and the piston 34, the guide 15 may be eliminated. Specifically, the spring bearing 21 and the piston 34 may be slidably in contact with the outer periphery of the outer shell 10 directly. In this case, it is preferred that the outer periphery of the outer shell 10 is smoothly formed.

While the above-described shock absorber A is configured to be, what is called, an inverted type in which the outer shell 10 is coupled to the vehicle body B and the rod 11 is coupled to the rear wheel W, the shock absorber A may be configured to be an upright type. In the upright type shock absorber A, the outer shell 10 is coupled to the rear wheel W and the rod 11 is coupled to the vehicle body B.

While the above-described shock absorber A is disposed between the vehicle body B and the rear wheel W of a motorcycle, this shock absorber A may be used for, for example, a saddle-ride type vehicle other than the motorcycle or an automobile.

These changes can be made irrespective of the configurations of the spring bearing 21, the stroke sensor 6, the restricting portion 7, and the adapter 4.

The embodiments of the present invention described above are merely illustration of some application examples of the present invention and not of the nature to limit the technical scope of the present invention to the specific constructions of the above embodiments.

The present application claims a priority based on Japanese Patent Application No. 2016-063047 filed with the Japan Patent Office on Mar. 28, 2016, all the contents of which are hereby incorporated by reference.

1. A shock absorber comprising:
a shock absorber main body;
a suspension spring configured to bias the shock absorber main body in an extension direction;
a spring bearing that supports one end of the suspension spring;
a jack configured to change an axial position of the spring bearing;
a ring-shaped adapter freely fitted to an outer periphery of the spring bearing;
a restricting portion disposed between the spring bearing and the adapter, the restricting portion restricting a movement of the adapter in an axial direction with respect to the spring bearing;
a rotation stop member mounted on the shock absorber main body to stop a rotation of the adapter; and
a stroke sensor disposed between the adapter and the rotation stop member.

2. The shock absorber according to claim 1, wherein
the adapter includes a slit at one or more positions in a circumferential direction.

3. The shock absorber according to claim 1, wherein
the restricting portion has a convex portion and a concave portion, the convex portion being disposed on any one of the spring bearing and the adapter, the concave portion being disposed on another one of the spring bearing and the adapter, the concave portion being fitted with the convex portion.
